(19) United States
(12) Patent Application Publication
(10) Pub. No.: US 2019/0169405 A1
(43) Pub. Date: Jun. 6, 2019

(54) RUBBER COMPOSITION

(71) Applicant: TOYO TIRE & RUBBER CO., LTD., Itami-shi (JP)

(72) Inventor: Norio Minouchi, Itami-shi (JP)

(73) Assignee: TOYO TIRE & RUBBER CO., LTD., Itami-shI (JP)

(21) Appl. No.: 16/196,864

(22) Filed: Nov. 20, 2018

(30) Foreign Application Priority Data
Dec. 5, 2017 (JP) 2017-233326
Dec. 5, 2017 (JP) 2017-233330

(51) Int. Cl. C08L 9/06; C08K 3/22

(52) U.S. Cl. CPC C08L 9/06; C08K 5/0025; C08K 2003/2296; C08K 3/22

(57) ABSTRACT

A rubber composition wherein a compounding amount of a solution-polymerized polystyrene butadiene rubber is 50 parts by mass or more and a compounding amount of a zinc-containing compound is less than 0.5 parts by mass, based on 100 parts by mass of a total amount of rubber components. It is preferable that the solution-polymerized polystyrene butadiene rubber is a solution-polymerized polystyrene butadiene rubber whose molecular terminal is modified.

### BACKGROUND OF THE INVENTION

### Field of the Invention

The present invention relates to a rubber composition useful as a raw material for producing a vulcanized rubber maintaining and improving low exothermic property while reducing the content of a zinc-containing compound.

### Description of the Related Art

In recent years, from the viewpoint of energy saving, development of low fuel consumption tires has been actively carried out in the tire industry, and it is said that improvement in low exothermic performance of rubber portion of a tire tread obtained particularly by vulcanization is indispensable in developing low fuel consumption tires.

Incidentally, rubber portions such as tire treads are produced by compounding a zinc-containing compound such as zinc oxide together with a vulcanizing agent such as sulfur and a vulcanization accelerator as raw materials in a rubber composition and vulcanizing the resulting rubber composition. Among these, metal compounds such as zinc-containing compounds are required to reduce the amount to be compounded from the viewpoint of preventing environmental pollution. However, as described in Non-Patent Document 1 below, zinc oxide plays an important role in rubber vulcanization, and if this oxide is lacked, the vulcanization accelerating effect remarkably decreases to reduce an elastic modulus of the vulcanized rubber. Therefore, metal compounds such as zinc oxide are actually used as indispensable materials in vulcanization situations of rubber compositions.

Patent Document 1 listed below describes a rubber composition aiming at improving tire physical properties while reducing the content of zinc oxide, specifically, a rubber composition having a content of zinc oxide of 1.0 part by mass or less and containing a specific zinc-containing compound.

### PRIOR ART DOCUMENT

### Patent Document

Patent Document 1: JP-A-2012-46602

### Non-Patent Document

Non-Patent Document 1: Tomoyuki KOMATSU, NIPPON GOMU KYOKAISHI (Journal of The Society of Rubber Industry, Japan), Vol. 82, No. 1, pp. 33-38, (2009)

### SUMMARY OF THE INVENTION

### Problems to Be Solved by the Invention

However, as a result of intensive investigations made by the present inventors, it was found that the technique described in the above patent document has a large content of zinc-containing compound and leaves much room for improvement from the viewpoint of prevention of environmental pollution.

The present invention has been made in view of the above circumstances, and it is an object of the present invention to provide a rubber composition useful as a raw material for producing a vulcanized rubber maintaining and improving low exothermic property while reducing the content of a zinc-containing compound.

### Means for Solving the Problem

In order to solve the above problems, the inventors of the present invention conducted intensive studies and discovered that the above problems can be solved by designing the compounding amount of a zinc-containing compound while compounding a specific rubber component. Specifically, the present invention has the following constitution.

That is, the present invention relates to a rubber composition in which a compounding amount of a solution-polymerized polystyrene butadiene rubber is 50 parts by mass or more and a compounding amount of a zinc-containing compound is less than 0.5 parts by mass, based on 100 parts by mass of a total amount of rubber components.

In the present invention, attention is focused on a solution-polymerized polystyrene butadiene rubber as a rubber component, and it is possible to maintain and improve strength properties and low exothermic properties of an obtained vulcanized rubber by a compounding design such that the compounding amount of a zinc-containing compound is specifically less than 0.5 parts by mass while maintaining the solution-polymerized polystyrene butadiene rubber as a main component at 50 parts by mass or more.

In the rubber composition, it is preferable that the solution-polymerized polystyrene butadiene rubber is a solution-polymerized polystyrene butadiene rubber whose molecular terminal has been modified. In such a constitution, attention is focused on a solution-polymerized polystyrene butadiene rubber in which the molecular terminal is particularly modified as a rubber component, and it is possible to suppress the thermal deterioration while maintaining and improving the strength properties and low exothermic properties of the obtained vulcanized rubber by a compounding design such that the compounding amount of the zinc-containing compound is specifically less than 0.5 parts by mass while maintaining the solution-polymerized polystyrene butadiene rubber as a main component at 50 parts by mass or more.

In the above rubber composition, it is preferable that X/Y is greater than 50 when the compounding amount of the solution-polymerized polystyrene butadiene rubber is X parts by mass and the compounding amount of the zinc-containing compound is Y parts by mass. In this case, strength properties and low exothermic properties of the obtained vulcanized rubber can be maintained and improved at a higher level, which is preferable.

From the viewpoint of prevention of environmental pollution, it is preferable that the rubber composition does not contain a metal oxide.

### DETAILED DESCRIPTION OF THE PREFERRED EMBODIMENTS

The rubber composition according to the present invention relates to a rubber composition in which a compounding amount of a solution-polymerized polystyrene butadiene rubber is 50 parts by mass or more and a compounding amount of a zinc-containing compound is less than 0.5 parts by mass, based on 100 parts by mass of a total amount of rubber components.

The solution-polymerized polystyrene butadiene rubber (hereinafter also referred to as “S-SBR”) is generally obtained by anionic polymerization of raw material monomers in a hydrocarbon, and S-SBR has a feature such that it can control both molecular weight distribution and vinyl content, compared to an emulsion-polymerized polystyrene butadiene rubber (hereinafter also referred to as “E-SBR”) obtained by an emulsion polymerization method (suspension polymerization method) in water. In the present invention, in order to maintain and improve the low exothermic property of the resulting vulcanized rubber at a higher level, it is preferable that in the microstructure of the butadiene part of S-SBR, the content of the vinyl group is preferably large, specifically, the vinyl content is preferably from 30 to 80% by mass, more preferably from 50 to 80% by mass. Further, when the total amount of the rubber component is 100 parts by mass, the compounding amount of the solution-polymerized polystyrene butadiene rubber is 50 parts by mass or more, preferably 60 parts by mass or more, more preferably 70 parts by mass or more.

The rubber composition according to the present invention may contain a rubber component other than. S-SBR as a rubber component, and when the rubber composition particularly contains at least one of E-SBR, natural rubber (NR) and polybutadiene rubber (BR) such a case is preferable because the WET performance of vulcanized rubber as well as fatigue resistance and tear resistance can be improved in a more well-balanced manner. Examples of diene rubbers which may be contained besides E-SBR, NR and BR include polyisoprene rubber (IR), chloroprene rubber (CR), nitrile rubber (NBR) and the like. It is also possible to suitably use those that are modified optionally at the terminal (for example, terminal modified SBR etc.) or those that are modified optionally by imparting desired properties (for example, modified NR).

In the present invention, examples of the zinc-containing compound include those known to a person skilled in the art, and zinc oxide can be exemplified representatively. addition to zinc oxide, a compound containing a zinc atom, a compound containing a zinc atom and a sulfur atom, and the like can be mentioned. From the viewpoint of prevention of environmental pollution and further from the viewpoint of maintaining and improving the low exothermic property of the obtained vulcanized rubber, when the total amount of the rubber component is set to 100 parts mass, the compounding amount of the zinc-containing compound is preferably less than 0.5 parts by mass, preferably less than 0.2 parts by mass, and it is preferable not to contain a zinc-containing compound. Similarly, for metal oxides, particularly zinc oxide, the compounding amount is preferably less than 0.5 parts by mass, preferably less than 0.2 parts by mass, and it is preferable not to contain a metal oxide, particularly zinc oxide.

In the present invention, if X/Y is greater than 50 when the compounding amount of the solution-polymerized polystyrene butadiene rubber is X parts by mass and the compounding amount of the zinc-containing compound is Y parts by mass, this is particularly preferable because the low exothermic performance of the resulting vulcanized rubber is particularly excellent. From the viewpoint of low exothermic performance of the vulcanized rubber, it is preferable that X/Y is greater than 100, more preferable that X/Y is greater than 200.

The rubber composition according to the present invention may contain carbon black as a filler. As the carbon black, in addition to carbon black used in ordinary rubber industry, such as SAF, ISAF, HAF, FEF, GPF and the like, conductive carbon black such as acetylene black and Ketjenblack can be used. When the total amount of the rubber component is 100 parts by mass, the rubber composition according to the present invention contains preferably 1 to 80 parts by mass of carbon black, and more preferably 5 to 60 parts by mass.

It is also preferable to contain silica as a filler. As the silica, wet silica, dry silica, sol-gel silica, surface treated silica and the like used for rubber reinforcement are used. Among them, wet silica is preferable. The compounding amount of silica is preferably from 20 to 120 parts by mass, more preferably from 40 to 100 parts by mass, based on 100 parts by mass of the total amount of the rubber component.

When silica is contained as a filler, it is also preferable to contain a silane coupling agent in conjunction with silica. The silane coupling agent is not particularly limited as long as it contains sulfur in the molecule, and various silane coupling agents compounded with silica in the rubber composition can be used. Examples of the silane coupling agent include sulfide silanes such as
bis(3-triethoxysilylpropyl)tetrasulfide (for example, “Si69”manufactured by Degussa),
bis(3-triethoxysilylpropyl)disulfide (for example, “Si75”manufactured by Degussa),
bis(2-triethoxysilylethyl)tetrasulfide,
bis(4-triethoxysilylbutyl)disulfide,
bis(3-trimethoxysilylpropyl)tetrasulfide, and
bis(2-trimethoxysilylethyl)disulfide; mercaptosilanes such as γ-mercaptopropyltrimethoxysilane,
γ-mercaptopropyltriethoxysilane,
mercaptopropylmethyldimethoxysilane,
mercaptopropyldimethylmethoxysilane, and
mercaptoethyltriethcxysilane; protected mercaptosilanes such as 3-octanoylthio-1-propyltriethozysilane and
3-propionylthiopropyltrimethoxysilane; and the like. The compounding amount of the silane coupling agent is preferably 1 to 20 parts by mass, more preferably 1 to 10 parts by mass, based on 100 parts by mass of silica.

The rubber composition according to the present invention may be compounded with a vulcanization compounding agent, an antioxidant, stearic acid, a softening agent (e.g. wax, oil, etc.), a processing aid, and the like, in addition to a rubber component containing at least S-SBR, carbon black, silica and a silane coupling agent.

Examples of the antioxidant include those commonly used for rubbers, such as an aromatic amine type antioxidant, an amine-ketone type antioxidant, a monophenol type antioxidant, a bisphenol type antioxidant, a polyphenol type antioxidant, a dithiocarbamate type antioxidant, and a thiourea type antioxidant, and these may be used singly or as an appropriate mixture of such antioxidants. The content of the antioxidant is preferably 0.5 to 10 parts by mass with respect to 100 parts by mass of the rubber component.

Examples of the vulcanization compounding agent include vulcanizing agents such as sulfur and organic peroxides, vulcanization accelerators, vulcanization acceleration aids, vulcanization retarders, and the like.

Sulfur as a vulcanization compounding agent may be ordinary sulfur for rubbers, and for example, powdered sulfur, precipitated sulfur, insoluble sulfur, highly dispersible sulfur and the like can be used. In consideration of physical properties and durability of rubber after vulcanization, the compounding amount of sulfur with respect to 100 parts by mass of rubber component is preferably 0.1 to 10 parts by mass in terms of sulfur content, more preferably 0.5 to 3 parts by mass.

Examples of the vulcanization accelerator include a sulfenamide type vulcanization accelerator, a thiuram type vulcanization accelerator, a thiazole type vulcanization accelerator, a thiourea type vulcanization accelerator, a guanidine type vulcanization accelerator, and a dithiocarbamate type vulcanization accelerator, which are commonly used for rubbers. These may be used singly or as an appropriate mixture thereof. The compounding amount of the vulcanization accelerator with respect to 100 parts by mass of the rubber component is preferably 0.1 to 10 parts by mass.

The rubber composition according to the present invention can be obtained by kneading a vulcanization compounding agent, an antioxidant, stearic acid, a softening agent (e.g. wax, oil, etc.), a processing aid and the like, in addition to a rubber component containing at least S-SBR, carbon black, silica and a silane coupling agent, using a kneading machine used in a usual rubber industry, such as a Banbury mixer, a kneader, a roll, or the like.

The compounding method of the respective components is not particularly limited, but may include a method in which compounding components other than the vulcanization compounding agent such as a sulfur-based vulcanizing agent and a vulcanization accelerator are previously kneaded to prepare a master batch and the remaining components are added thereto, then the mixture is further kneaded, a method of adding and kneading each component in an arbitrary order, a method of simultaneously adding all the components and kneading them, and the like.

The rubber composition according to the present invention may contain 50 parts by mass or more as the compounding amount of the solution-polymerized polystyrene butadiene rubber modified at the molecular terminal and less than 0.5 parts by mass as the compounding amount of the zinc-containing compound when the total amount of the rubber component is 100 parts by mass.

The solution-polymerized polystyrene butadiene rubber (hereinafter also referred to as “S-SBR”) is generally obtained by anionic polymerization of raw material monomers in a hydrocarbon, and has characteristics such that both molecular weight distribution and vinyl content can be controlled as compared to an emulsion-polymerized polystyrene-butadiene rubber (hereinafter also referred to as “E-SBR”) obtained by emulsion polymerization in water (radical polymerization method). The present invention is particularly characterized in that S-SBR whose molecular terminal is modified (hereinafter also referred to as “modified S-SBR”) is used. Examples of the S-SBR whose molecular terminal is modified include an amine-modified S-SBR containing a diglycidylamine compound or a cyclic amide compound, an alkoxy-modified S-SBR containing a halogenated alkoxysilane or glycidoxypropylmethoxysilane, and the like. Among them, it is preferable to use an amine-modified S-SBR. In order to maintain and improve the low exothermic property of the resulting vulcanized rubber at a higher level, it is preferable that there are many vinyl groups in the microstructure of butadiene part of the modified S-SBR, specifically vinyl content is preferably from 30 to 80% by mass, and more preferably from 50 to 80% by mass. When the total amount of the rubber component is 100 parts by mass, the compounding amount of the modified S-SBR is 50 parts by mass or more, preferably 65 parts by mass or more, more preferably 75 parts by mass or more.

The rubber composition may contain a rubber component other than the modified S-SBR, and when at least one kind of E-SBR, natural rubber (NR) and polybutadiene rubber (BR) is contained in addition to S-SBR in which the molecular terminal is not modified, the WET performance of the vulcanized rubber as well as fatigue resistance and tear resistance can be improved in a more well-balanced manner, which is preferable. Examples of diene type rubbers which may be contained besides S-SBR, E-SBR, NR and BR whose molecular terminals are not modified include polyisoprene rubber (IR), chlcrcprene rubber (CR), nitrile rubber (NBR), and the like. It is also possible to suitably use those which are optionally modified at the terminal (for example, terminal-modified SBR etc.) or those which are optionally modified by imparting desired properties (for example, modified NR).

In the rubber composition, examples of the zinc-containing compounds include those known to a person skilled in the art, and zinc oxide can be exemplified representatively. In addition to zinc oxide, a compound containing a zinc atom, a compound containing a zinc atom and a sulfur atom, and the like can be mentioned. From the viewpoint of prevention of environmental pollution and further from the viewpoint of maintaining and improving low exothermic property of the obtained vulcanized rubber, when the total amount of the rubber component is 100 parts by mass, the compounding amount of the zinc-containing compound is preferably less than 0.5 parts by mass, preferably less than 0.2 parts by mass, and it is preferable not to contain a zinc-containing compound. Similarly, for metal oxides, particularly zinc oxide, the compounding amount is preferably less than 0.5 parts by mass, preferably less than 0.2 parts by mass, and it is preferable not to contain a metal oxide, particularly zinc oxide.

In the rubber composition, when X/Y is greater than 50 in the case where the compounding amount of the modified S-SBR is X parts by mass and the compounding amount of the zinc-containing compound is Y parts by mass, the low exothermic performance of the resulting vulcanized rubber is particularly excellent, which is preferable. From the viewpoint of low exothermic performance of the vulcanized rubber, X/Y is preferably greater than 100, more preferably greater than 200.

In the rubber composition, various compounding agents (e.g. fillers, antioxidants, vulcanization compounding agents, vulcanization accelerators, etc.) and a compounding method and the like can adopt the same constitution as described above.

### EXAMPLES

Examples that specifically show the constitution and effect of the present invention are described below. Evaluation items in examples and the like were evaluated on rubber samples obtained by heating and vulcanizing each rubber composition at 150° C. for 30 minutes based on the following evaluation conditions.

### (1) Vulcanization Behavior Measurement Test of Unvulcanized Rubber Composition

In the vulcanization behavior measurement test of an unvulcanized rubber composition by a rheometer, MH-ML was calculated when the maximum value of torque was MH and the minimum value was ML. Evaluations of Reference Examples 2, 4, 6, and 8 and Examples 1-6 were performed respectively by index evaluations when MH-ML of each of Reference Examples 1, 3, 5, and 7 and Comparative Examples 1-6 was taken as 100. When the numerical value is low, this means that the sulfur vulcanization of the rubber component has not sufficiently progressed.

### (2) Tensile Properties of Vulcanized Rubber

A sample prepared by using a JIS No. 3 dumbbell was measured for 100% modulus M100 (MPa) of the obtained vulcanized rubber in accordance with JIS-K 6251. Evaluations of Reference Examples 2, 4, 6, and 8 and Examples 1-6 were performed respectively by index evaluations when M100 of each of Reference Examples 1, 3, 5, and 7 and Comparative Examples 1-6 was taken as 100. When the numerical value is low, this means that the sulfur vulcanization of the rubber component has not sufficiently progressed.

### (3) Low Exothermic Performance of Vulcanized Rubber

Using a viscoelasticity tester manufactured by Toyo Seiki Seisaku-sho, Ltd., a loss factor tan δ was measured under the conditions of an initial strain of 10%, a dynamic strain of 1%, a frequency of 10 Hz, and a temperature of 60° C. Evaluations of Reference Examples 2, 4, 6, and 8 and Examples 1-6 were performed respectively by index evaluations when tan δ of each of Reference Examples 1, 3, 5, and 7 and Comparative Examples 1-6 was taken as 100. When the numerical value obtained is low, this means that the obtained vulcanized rubber is excellent in the low exothermic performance.

### (Preparation of Rubber Composition)

The rubber compositions of Reference Examples 1-8, Examples 1-6 and Comparative Examples 1-6 were compounded according to the compounding recipes shown in Tables 1 and 2 and then kneaded using a usual Banbury mixer to prepare rubber compositions. The compounding agents shown in Tables 1 and 2 are shown below (in Tables 1 and 2, the compounding amounts of respective compounding agents are shown in parts by mass per 100 parts by mass of the rubber component).
a) Rubber component

S-SBR: “Tuf 2831” (styrene content 26% by mass, butadiene part microstructure; cis content 20% by mass, trans content 28% by mass, vinyl content 52% by mass) manufactured by Asahi Kasei Corporation

E-SBR; “SBR 1502” (styrene content 26% by mass, butadiene part microstructure; cis content 12% by mass, trans content 74% by mass, vinyl content 14% by mass) manufactured by JSR Corporation

NR; “RSS #3”

BR “BR 150B” (cis content 96% by mass) manufactured by Ube Industries, Ltd.
b) Carbon black (N339); “Seast KH”, manufactured by Tokai Carbon Co., Ltd.
c) Silica: “Nipsil AQ”, manufactured by Tosoh Silica Corporation
d) Silane coupling agent: “Si69”, manufactured by Evonik Degussa
e) Oil: “Process NC-140” manufactured by JX Nippon Oil & Energy Corporation
f) Zinc oxide; “Zinc oxide No. 1”manufactured by Mitsui Mining & Smelting Co., Ltd.
g) Stearic acid; “Lunac S-20”manufactured by Kao Corporation
h) Antioxidant: “Antigene 6C” manufactured by Sumitomo Chemical Co., Ltd.
i) Sulfur: “5% oil-filled fine powder sulfur” manufactured by Tsurumi Chemical Industry Co., Ltd.
j) Vulcanization accelerator

CBS: “Nocceler CZ-G (CZ)” manufactured by Ouchi Shinko Chemical Industrial Co., Ltd.

DPG: “Nocceler D”manufactured by Ouchi Shinko Chemical Industrial Co., Ltd.

TABLE 1

| | Refer- | Refer- | Refer- | Refer- | Refer- | Refer- | Compar- | | Compar- | | Compar- | |
|---|---|---|---|---|---|---|---|---|---|---|---|---|
| | ence | ence | ence | ence | ence | ence | ative | | ative | | ative | |
| | Exam- | Exam- | Exam- | Exam- | Exam- | Exam- | Exam- | Exam- | Exam- | Exam- | Exam- | Exam- |
| | ple 1 | ple 2 | ple 3 | ple 4 | ple 5 | ple 6 | ple 1 | ple 1 | ple 2 | ple 2 | ple 3 | ple 3 |
| NR | 100 | 100 | — | — | — | — | — | — | — | — | — | — |
| BR | — | — | 100 | 100 | — | — | — | — | — | — | — | — |
| E-SBR | — | — | — | — | 100 | 100 | — | — | — | — | — | — |
| S-SBR | — | — | — | — | — | — | 100 | 100 | 100 | 100 | 100 | 100 |
| Carbon black | 50 | 50 | 50 | 50 | 50 | 50 | 50 | 50 | 25 | 25 | | |
| Silica | — | — | — | — | — | — | — | — | 25 | 25 | 70 | 70 |
| Silane coupling agent | — | — | — | — | — | — | — | — | 2.5 | 2.5 | 7 | 7 |
| Oil | — | — | 40 | 40 | 20 | 20 | 20 | 20 | 20 | 20 | 35 | 35 |
| Zinc oxide | 3 | — | 3 | — | 3 | — | 3 | — | 3 | — | 3 | — |
| STEARIC ACID | 2 | 2 | 2 | 2 | 2 | 2 | 2 | 2 | 2 | 2 | 2 | 2 |
| Antioxidant | 2 | 2 | 2 | 2 | 2 | 2 | 2 | 2 | 2 | 2 | 2 | 2 |
| Sulfur | 2 | 2 | 2 | 2 | 2 | 2 | 2 | 2 | 2 | 2 | 2 | 2 |
| Vulcanization | 1.5 | 1.5 | 1.5 | 1.5 | 1.5 | 1.5 | 1.5 | 1.5 | 1.5 | 1.5 | 2 | 2 |
| accelerator CBS | | | | | | | | | | | | |
| Vulcanization | 0.5 | 0.5 | 0.5 | 0.5 | 0.5 | 0.5 | 0.5 | 0.5 | 0.5 | 0.5 | 1 | 1 |
| accelerator DPG | | | | | | | | | | | | |
| (X/Y) | — | — | — | — | — | — | 33.3 | ∞ | 33.3 | ∞ | 33.3 | ∞ |
| Unvulcanized physical | 100 | 32 | 100 | 60 | 100 | 82 | 100 | 107 | 100 | 101 | 100 | 97 |
| properties (MH - ML) | | | | | | | | | | | | |
| Tensile properties of | 100 | 25 | 100 | 36 | 100 | 75 | 100 | 114 | 100 | 108 | 100 | 103 |
| vulcanized rubber | | | | | | | | | | | | |
| (M100) | | | | | | | | | | | | |
| Low exothermic | 100 | 130 | 100 | 124 | 100 | 120 | 100 | 96 | 100 | 95 | 100 | 96 |
| performance of | | | | | | | | | | | | |
| vulcanized rubber | | | | | | | | | | | | |
| (tanδ) | | | | | | | | | | | | |

TABLE 2

| | Comparative | | Comparative | | Reference | Reference | Comparative | |
|---|---|---|---|---|---|---|---|---|
| | Example 4 | Example 4 | Example 5 | Example 5 | Example 7 | Example 8 | Example 6 | Example 6 |
| NR | 30 | 30 | — | — | — | — | — | — |
| BR | — | — | 20 | 20 | — | — | — | — |
| E-SBR | — | — | — | — | 65 | 65 | 40 | 40 |
| S-SBR | 70 | 70 | 80 | 80 | 35 | 35 | 60 | 60 |
| Carbon black | 50 | 50 | 20 | 20 | 5 | 5 | 5 | 5 |
| Silica | — | — | 60 | 60 | 80 | 80 | 110 | 110 |
| Silane coupling agent | — | — | — | — | — | — | — | — |
| Oil | 20 | 20 | 25 | 25 | 40 | 40 | 50 | 50 |
| Zinc oxide | 3 | — | 3 | — | 3 | — | 3 | — |
| Stearic acid | 2 | 2 | 2 | 2 | 2 | 2 | 2 | 2 |
| Antioxidant | 2 | 2 | 2 | 2 | 2 | 2 | 2 | 2 |
| Sulfur | 2 | 2 | 2 | 2 | 2 | 2 | 2 | 2 |
| Vulcanization | 1.5 | 1.5 | 2 | 2 | 2 | 2 | 2 | 2 |
| accelerator CBS | | | | | | | | |
| Vulcanization | 0.5 | 0.5 | 1 | 1 | 1 | 1 | 1 | 1 |
| accelerator DPG | | | | | | | | |
| (X/Y) | 23.3 | ∞ | 26.7 | ∞ | 11.7 | ∞ | 20 | ∞ |
| Unvulcanized physical | 100 | 102 | 100 | 98 | 100 | 88 | 100 | 97 |
| properties (MH - ML) | | | | | | | | |
| Tensile properties of | 100 | 105 | 100 | 100 | 100 | 89 | 100 | 104 |
| vulcanized rubber | | | | | | | | |
| (M100) | | | | | | | | |
| Low exothermic | 100 | 97 | 100 | 97 | 100 | 110 | 100 | 97 |
| performance of | | | | | | | | |
| vulcanized rubber | | | | | | | | |
| (tan δ) | | | | | | | | |

From the results of Reference Examples 1-6 in Table 1, it can be seen that when the rubber composition containing NR, BR or E-SBR as a main component does not contain zinc oxide, sulfur vulcanization of the rubber component does not proceed sufficiently, because of which the tensile properties of the obtained vulcanized rubber are greatly deteriorated and the low exothermic property is also deteriorated. On the other hand, from the comparison results between Comparative Example 1 Example 1, the comparison results between Comparative Example 2 and Example 2, and the comparison results between Comparative Example 3 and Example 3, it is understood that the rubber composition mainly composed of S-SBR, even when zinc oxide is not contained, sufficiently accelerates the sulfur vulcanization of the rubber component and also improves the tensile properties of the obtained vulcanized rubber. It is also understood that the low exothermic property is improved as compared with the cases without zinc oxide. For S-SBR, it is found that the above effects are achieved even if the filler is carbon black, silica, or a mixture thereof.

From the comparison results between Comparative Example 4 and Example 4 and the comparison results between Comparative Example 5 and Example 5 in Table 2, it is understood that when S-SBR is contained in an amount of 50 parts by mass or more, a rubber composition containing NR or BR sufficiently accelerates sulfur vulcanization of the rubber component even if zinc oxide is not contained, and the obtained vulcanizes rubber improves the low exothermic property while maintaining the tensile properties. On the other hand, from the comparison results between Reference Example 7 and Reference Example 8, it can be seen that when the content of S-SBR is less than 50 parts by mass and zinc oxide is not contained, sulfur vulcanization of the rubber component does not proceed sufficiently, and thus the tensile properties of the obtained vulcanized rubber as well as the low exothermic property deteriorates. However, from the comparison results between Comparative Example 6 and Example 6, even in the case of a rubber composition containing 40 parts by mass of E-SBR and 50 parts by mass or more of S-SBR and not containing zinc oxide, it is understood that the sulfur vulcanization of the rubber component proceeds sufficiently, and the low exothermic property is improved while maintaining the tensile properties of the obtained vulcanized rubber.

Hereinafter, examples and the like that specifically show the constitution and effect of another embodiment of the present invention will be described. Evaluation items in the examples and the like were examined on rubber samples obtained by heating and vulcanizing each rubber composition at 150° C. for 30 minutes based on the following evaluation conditions.

### (1) Vulcanization Behavior Measurement Test of Unvulcanized Rubber Composition

In the vulcanization behavior measurement test of an unvulcanized rubber composition by a rheometer, MH-ML was calculated when the maximum value of torque was MH and the minimum value of torque was ML. Evaluations of Reference Examples 10, 12, and 14 and Examples 7-11 were performed respectively by index evaluations when NH-ML of each of Reference Examples 9, 11 and 13 and Comparative Examples 7-11 was taken as 100. When the numerical value is low, this means that the sulfur vulcanization of the rubber component has not sufficiently progressed.

### (2) Tensile Properties of Vulcanized Rubber (Initial Stage)

A sample prepared by using a JIS No. 3 dumbbell was measured for 100% modulus M100 (MPa) of the obtained vulcanized rubber in accordance with JIS-K 6251. Evaluations of Reference Examples 10, 12 and 14 and Examples 7-11 were performed respectively by index evaluations when M100 of each of Reference Examples 9, 11 and 13 and Comparative Examples 7-11 was taken as 100. When the numerical value obtained is low, this means that the sulfur vulcanization of the rubber component has not sufficiently progressed.

### (3) Tensile Properties of Vulcanized Rubber (After Aging)

A sample prepared by using a JIS No. 3 dumbbell was measured for 100% modulus M100 (MPa) of the obtained vulcanized rubber in accordance with JIS-K 6251. This measurement result was taken as an initial M100. Next, the obtained vulcanized rubber was aged by allowing to stand at 80° C. for 4 days, and then 100% modulus M100 (MPa) was measured. This measurement result was taken as M100 after aging. In general, the vulcanized rubber after the aging test becomes harder than before aging (that is, M100 increases after aging as compared with the initial M100). Therefore, when the measurement result of the initial M100 is taken as 100, the closer M100 is to 100 after aging, the more the thermal degradation is suppressed. Evaluation was performed by an index evaluation for each of Reference Examples 10, 12 and 14 and Examples 7-11 when the rate of change from the initial M100 of Reference Examples 9, 11, and 13 and Comparative Examples 7-11 to M100 after aging was taken as 100. When the numerical value is close to 100, this means that thermal deterioration of the vulcanized rubber is suppressed.
(4) Low Exothermic Performance of Vulcanized Rubber

Using a viscoelasticity tester manufactured by Toyo Seiki Seisaku-sho, Ltd., a loss factor tan δ was measured under the conditions of an initial strain of 10%, a dynamic strain of 1%, a frequency of 10 Hz, and a temperature of 60° C. Evaluations of Reference Examples 10, 12 and 14 and Example 7-11 were performed respectively by index evaluations when tan δ of each of Reference Examples 9, 11 and 13 and Comparative Examples 7-11 was taken as 100. When the obtained numerical value is low, this means that the obtained vulcanized rubber is excellent in low exothermic performance.

### (Preparation of Rubber Composition)

The rubber compositions of Reference Examples 9-14, Examples 7-11 and Comparative Examples 7-11 were compounded according to the compounding recipes of Tables 3 and 4 and then kneaded using a usual Banbury mixer to prepare rubber compositions. The compounding agents shown in Tables 3 and 4 are shown below (in Tables 3 and 4, the compounding amounts of the respective compounding agents are shown in parts by mass per 100 parts by mass of the rubber component).
a) Rubber component

Modified S-SBR: “HPR 350” (styrene content 20% by mass, microstructure of butadiene part; cis content 17% by mass, trans content 27% by mass, vinyl content 56% by mass), manufactured by JSR Corporation

S-SBR: “Tuf 2831” (styrene content 26% by mass, microstructure of butadiene part; cis content 20% by mass, trans content 28% by mass, vinyl content 52% by mass), manufactured by Asahi Kasei Corporation

E-SBR; “SBR 1502” (styrene content 26% by mass, microstructure of butadiene part; cis content 12% by mass, trans content 74% by mass, vinyl content 14% by mass), manufactured by JSR Corporation

NR; “RSS #3”

BR; “BR 150B” (cis content 96% by mass), manufactured by Ube Industries, Ltd.
b) Carbon black (N339); “Seast KH”, manufactured by Tokai Carbon Co., Ltd.
c) Silica: “Nipsil AQ”, manufactured by Tosoh Silica Corporation
d) Silane coupling agent: “Si 69”, manufactured by Evonik Degussa
e) Oil: “Process NC-140”, manufactured by JX Nippon Oil & Energy Corporation
f) Zinc oxide; “Zinc oxide No. 1”, manufactured by Mitsui Mining & Smelting Co., Ltd.
g) Stearic acid; “Lunac S-20”, manufactured by Kao Corporation
h) Antioxidant: “Antigene 6C”, manufactured by Sumitomo Chemical Co., Ltd.
i) Sulfur: “5% oil-filled fine powder sulfur”, manufactured by Tsurumi Chemical Industry Co., Ltd.
j) Vulcanization accelerator

TABLE 3

| | Reference | Reference | Reference | Reference | Comparative | | Comparative | |
|---|---|---|---|---|---|---|---|---|
| | Example 9 | Example 10 | Example 11 | Example 12 | Example 7 | Example 7 | Example 8 | Example 8 |
| NR | — | — | — | — | — | — | — | — |
| BR | — | — | — | — | — | — | — | — |
| E-SBR | 100 | 100 | — | — | — | — | — | — |
| S-SBR | — | — | 100 | 100 | — | — | — | — |
| Modified S-SBR | — | — | — | — | 100 | 100 | 100 | 100 |
| Carbon black | 50 | 50 | 50 | 50 | 25 | 25 | — | — |
| Silica | — | — | — | — | 25 | 25 | 70 | 70 |
| Silane coupling agent | — | — | — | — | 2.5 | 2.5 | 7 | 7 |
| Oil | 20 | 20 | 20 | 20 | 20 | 20 | 35 | 35 |
| Zinc oxide | 3 | — | 3 | — | 3 | — | 3 | — |
| Stearic acid | 2 | 2 | 2 | 2 | 2 | 2 | 2 | 2 |
| Antioxidant | 2 | 2 | 2 | 2 | 2 | 2 | 2 | 2 |
| Sulfur | 2 | 2 | 2 | 2 | 2 | 2 | 2 | 2 |
| Vulcanization | 1.5 | 1.5 | 1.5 | 1.5 | 1.5 | 1.5 | 2 | 2 |
| accelerator CBS | | | | | | | | |
| Vulcanization | 0.5 | 0.5 | 0.5 | 0.5 | 0.5 | 0.5 | 1 | 1 |
| accelerator DPG | | | | | | | | |
| (X/Y) | — | — | — | — | 33.3 | ∞ | 33.3 | ∞ |
| Unvulcanized physical | 100 | 82 | 100 | 107 | 100 | 102 | 100 | 98 |
| properties (MH - ML) | | | | | | | | |
| Tensile properties of | 100 | 75 | 100 | 114 | 100 | 109 | 100 | 103 |
| vulcanized rubber | | | | | | | | |
| (INITIAL STAGE) | | | | | | | | |
| Tensile properties of | 100 | 140 | 100 | 117 | 100 | 98 | 100 | 99 |
| vulcanized rubber | | | | | | | | |
| (After aging) | | | | | | | | |
| Low exothermic | 100 | 120 | 100 | 96 | 100 | 95 | 100 | 95 |
| performance of | | | | | | | | |
| vulcanized rubber | | | | | | | | |
| (tanδ) | | | | | | | | |

TABLE 4

| | Comparative | | Comparative | | Reference | Reference | Comparative | |
|---|---|---|---|---|---|---|---|---|
| | Example 9 | Example 9 | Example 10 | Example 10 | Example 13 | Example 14 | Example 11 | Example 11 |
| NR | 30 | 30 | — | — | — | — | — | — |
| BR | — | — | 20 | 20 | — | — | — | — |
| E-SBR | — | — | — | — | 65 | 65 | 40 | 40 |
| S-SBR | — | — | — | — | — | — | — | — |
| Modified S-SBR | 70 | 70 | 80 | 80 | 35 | 35 | 60 | 60 |
| Carbon black | — | — | 20 | 20 | 5 | 5 | 5 | 5 |
| Silica | 70 | 70 | 60 | 60 | 80 | 80 | 110 | 110 |
| Silane coupling agent | 7 | 7 | 6 | 6 | 8 | 8 | 11 | 11 |
| Oil | 30 | 30 | 25 | 25 | 40 | 40 | 50 | 50 |
| Zinc oxide | 3 | — | 3 | — | 3 | — | 3 | — |
| Stearic acid | 2 | 2 | 2 | 2 | 2 | 2 | 2 | 2 |
| Antioxidant | 2 | 2 | 2 | 2 | 2 | 2 | 2 | 2 |
| Sulfur | 2 | 2 | 2 | 2 | 2 | 2 | 2 | 2 |
| Vulcanization | 1.5 | 1.5 | 2 | 2 | 2 | 2 | 2 | 2 |
| accelerator CBS | | | | | | | | |
| Vulcanization | 0.5 | 0.5 | 1 | 1 | 1 | 1 | 1 | 1 |
| accelerator DPG | | | | | | | | |
| (X/Y) | 23.3 | ∞ | 26.7 | ∞ | 11.7 | ∞ | 20 | ∞ |
| Unvulcanized physical | 100 | 100 | 100 | 99 | 100 | 84 | 100 | 99 |
| properties (MH - ML) | | | | | | | | |
| Tensile properties of | 100 | 102 | 100 | 102 | 100 | 85 | 100 | 102 |
| vulcanized rubber | | | | | | | | |
| (Initial stage) | | | | | | | | |
| Tensile properties of | 100 | 100 | 100 | 101 | 100 | 122 | 100 | 98 |
| vulcanized rubber | | | | | | | | |
| (After aging) | | | | | | | | |
| Low exothermic | 100 | 96 | 100 | 96 | 100 | 110 | 100 | 97 |
| performance (tanδ) | | | | | | | | |

From the results of Reference Examples 9-10 in Table 3, it can be seen that when the rubber composition containing E-SBR as a main component does not contain zinc oxide, sulfur vulcanization of the rubber component does not proceed sufficiently, because of which the tensile properties of the obtained vulcanized rubber are greatly deteriorated and the low exothermic property is also deteriorated. On the other hand, from the comparison results between Reference Example 11 and Reference Example 12, it is understood that the rubber composition composed mainly of S-SBR sufficiently accelerates the sulfur vulcanization of the rubber component and also improves the tensile properties of the obtained vulcanized rubber, even when zinc oxide is not contained in the composition In addition, it is understood that the low exothermic property is more improved as compared with the case without zinc oxide. However, in Reference Example 12, the tensile properties after aging greatly increased, indicating that thermal deterioration was not suppressed. On the other hand, from the comparison results between Comparative Example 7 and Example 7 and the comparison results between Comparative Example 8 and Example 8, it is understood that when the modified S-SBR was used, almost no change was observed in tensile properties after aging, and exothermic deterioration was suppressed.

From the comparison results of Comparative Example 9 and Example 9, the comparison results of Comparative Example 10 and Example 10, and the comparison results of Comparative Example 11 and Example 11 in Table 4, it can be seen that when a modified S-SBR is used as a main component, even a vulcanized rubber of a rubber composition containing NR, BR or E-SBR hardly changes the tensile properties after aging and suppresses the thermal deterioration. On the other hand, from the results of Reference Examples 13-14, it can be seen that in the case of a rubber composition not containing a modified S-SBR as a main component and not containing zinc oxide, sulfur vulcanization of the rubber component does not sufficiently proceed, and thus the tensile properties of the resulting vulcanized rubber are greatly deteriorated and the low exothermic property is also deteriorated.

What is claimed is:

1. A rubber composition wherein a compounding amount of a solution-polymerized polystyrene butadiene rubber is 50 parts by mass or more and a compounding amount of a zinc-containing compound is less than 0.5 parts by mass, based on 100 parts by mass of a total amount of rubber components.

2. The rubber composition according to claim 1, wherein the solution-polymerized polystyrene butadiene rubber is a solution-polymerized polystyrene butadiene rubber whose molecular terminal is modified.

3. The rubber composition according to claim 1, wherein X/Y is greater than 50 when the compounding amount of the solution-polymerized polystyrene butadiene rubber is X parts by mass and the compounding amount of the zinc-containing compound is Y parts by mass.

4. The rubber composition according to claim 1, which does not contain a metal ozide.
